(19) United States
(12) Patent Application Publication
(10) Pub. No.: US 2024/0013492 A1
(43) Pub. Date: Jan. 11, 2024

(54) IMAGE PROCESSING APPARATUS, IMAGE PROCESSING METHOD, AND IMAGE PROCESSING SYSTEM

(71) Applicant: SONY GROUP CORPORATION, TOKYO (JP)

(72) Inventor: DAISUKE TAHARA, TOKYO (JP)

(21) Appl. No.: 18/249,868

(22) PCT Filed: Oct. 15, 2021
(86) PCT No.: PCT/JP2021/038168

§ 371 Date: Apr. 20, 2023

(30) Foreign Application Priority Data
Oct. 29, 2020 (JP) 2020-181082

(51) Int. Cl. G06T 19/00; G06T 7/73

(52) U.S. Cl. CPC G06T 19/006; G06T 7/73

(57) ABSTRACT

The present technology relates to an image processing apparatus, an image processing method, and an image processing system that achieve easy creation of a composite video. The image processing apparatus includes a composite image generation unit that generates a composite image using a panel including captured image information regarding a subject of a captured image and polygon information corresponding to an imaging angle of view of the captured image in a three-dimensional space. The captured image information can be set such that a region other than the subject in the captured image is set to be transparent, and the polygon information can be a four-vertex planar polygon. The present technology can be applied to, for example, a virtual studio system.

### TECHNICAL FIELD

The present technology relates to an image processing apparatus, an image processing method, and an image processing system, and relates to, for example, an image processing apparatus, an image processing method, and an image processing system suitable for being applied when different images are composed with each other.

### BACKGROUND ART

In the chroma key composition technique used in movies and television broadcasting, a performer is imaged mainly with a green backdrop or a blue backdrop as a background. After the operation of segmenting the performer from the captured moving image is performed, a separately prepared moving image is composed with the background, and the segmented image is corrected or adjusted to become an appropriate size or to be in an appropriate position (see, for example, Patent Document 1).

### CITATION LIST

### Patent Document Patent Document 1: Japanese Patent Application Laid-Open No. 2004-56742

### SUMMARY OF THE INVENTION

### Problems to be Solved by the Invention

In a case where images are composed by a chroma key composition technique or the like, there are possibilities that a background image needs to be prepared for each viewpoint in order to perform viewpoint movement, the background image and the image of the performer are difficult to be aligned with each other, the load on the editor is large, there is a difficulty in tracking the movement of the performer, and the movement of the performer is restricted. According to the conventional technique, there is a limitation on a degree of freedom in a background image that can be used for composition and in a range in which the performer can move.

It is desired to increase the degree of freedom in the background image that can be used for composition and the range in which the performer can move, and to reduce the load on the editor.

The present technology has been made in view of such a situation, and an object thereof is to realize composition with a higher degree of freedom and reduction of the load on the editor.

### Solutions to Problems

A first image processing apparatus according to one aspect of the present technology is an image processing apparatus including a composite image generation unit that generates a composite image by using a panel including captured image information regarding a subject of a captured image and polygon information corresponding to an imaging angle of view of the captured image in a three-dimensional space.

A first image processing method according to one aspect of the present technology is an image processing method including an image processing apparatus generating a composite image by using a panel including captured image information regarding a subject of a captured image and polygon information corresponding to an imaging angle of view of the captured image in a three-dimensional space.

A second image processing apparatus according to one aspect of the present technology is an image processing apparatus including a generation unit that generates, from an image having a predetermined subject captured, captured image information in which a region other than the predetermined subject is set to transparent, and generates a panel to be composed with another image by pasting the captured image information on a planar polygon corresponding to an imaging angle of view in a three-dimensional space.

A second image processing method according to one aspect of the present technology is an image processing method including an image processing apparatus generating, from an image having a predetermined subject captured, captured image information in which a region other than the predetermined subject is set to transparent, and generating a panel to be composed with another image by pasting the captured image information on a planar polygon corresponding to an imaging angle of view in a three-dimensional space.

An image processing system according to one aspect of the present technology is an image processing system including an image capturing unit that captures an image of a subject, and a processing unit that processes a captured image from the image capturing unit, in which the processing unit includes a composite image generation unit that generates a composite image by using a panel including captured image information regarding a subject of the captured image and polygon information corresponding to an imaging angle of view of the captured image in a three-dimensional space.

In the first image processing apparatus and the first image processing method according to one aspect of the present technology, the composite image is generated by using the panel including the captured image information regarding the subject of the captured image and the polygon information corresponding to the imaging angle of view of the captured image in the three-dimensional space.

In the second image processing apparatus and the second image processing method according to one aspect of the present technology, the captured image information in which the region other than the predetermined subject is set to transparent is generated from the image having the predetermined subject captured, and the panel to be composed with another image is generated by pasting the captured image information on the planar polygon corresponding to the imaging angle of view in the three-dimensional space.

The image processing system according to one aspect of the present technology includes the image capturing unit that captures the image of a subject, and the processing unit that processes the captured image from the image capturing unit, in which the processing unit causes the composite image to be generated by using the panel including the captured image information regarding the subject of the captured image and the polygon information corresponding to the imaging angle of view of the captured image in the three-dimensional space.

Note that the image processing apparatus may be an independent apparatus or an internal block constituting one apparatus.

### BRIEF DESCRIPTION OF DRAWINGS

FIG. 1 is a diagram showing a configuration of one embodiment of an image processing system to which the present technology is applied.

FIG. 2 is a diagram showing another configuration example of the image processing system.

FIG. 3 is a diagram for explaining arrangement of cameras.

FIG. 4 is a diagram showing a configuration example of an image processing apparatus.

FIG. 5 is a diagram for explaining processing of a two-dimensional joint detection unit.

FIG. 6 is a diagram for explaining processing of a cropping unit.

FIG. 7 is a diagram for explaining processing of a camera position estimation unit.

FIG. 8 is a diagram for explaining processing of a person crop panel generation unit.

FIG. 9 is a diagram for explaining a person crop panel.

FIG. 10 is a diagram showing a configuration example of a virtual studio rendering unit.

FIG. 11 is a diagram showing a positional relationship between a virtual studio and a performer.

FIG. 12 is a diagram showing an example of a composite image.

FIG. 13 is a diagram showing a positional relationship between the virtual studio and the performer.

FIG. 14 is a diagram showing an example of the composite image.

FIG. 15 is a diagram for explaining enlargement and reduction of the person crop panel.

FIG. 16 is a diagram showing a positional relationship between the virtual studio and the performer.

FIG. 17 is a diagram showing an example of the composite image.

FIG. 18 is a diagram showing a positional relationship between the virtual studio and the performer.

FIG. 19 is a diagram showing an example of the composite image.

FIG. 20 is a flowchart for explaining processing of the image processing apparatus.

FIG. 21 is a diagram for explaining an application example of the person crop panel.

FIG. 22 is a diagram for explaining an application example of the person crop panel.

FIG. 23 is a diagram for explaining an application example of the person crop panel.

FIG. 24 is a diagram showing a configuration example of a personal computer.

### MODE FOR CARRYING OUT THE INVENTION

Hereinafter, modes for carrying out the present technology (hereinafter, referred to as an embodiment) is described below.

<Configuration of Image Processing System>

The present technology can be applied to, for example, a case where a captured image of a performer is composed with an electronic video (computer graphics (CG)), and can be applied to a system related to a studio in a virtual space called a virtual studio or the like. In the virtual studio, for example, a CG image obtained by copying the studio and the captured image of the performer are composed with each other. In the following description, a case where the present technology is applied to a system called the virtual studio is described as an example.

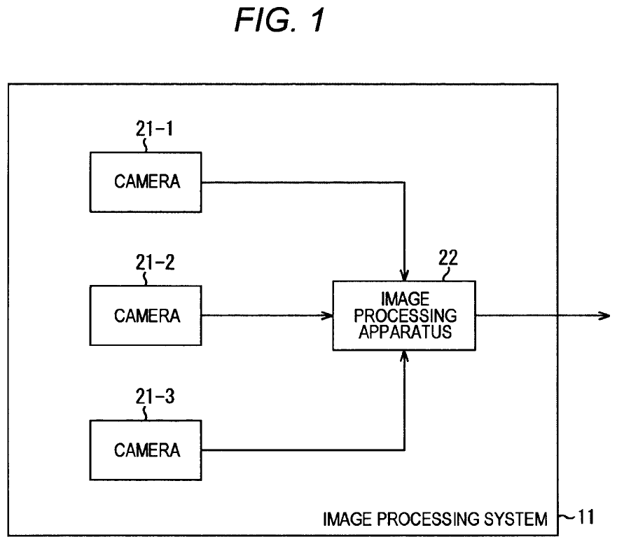

FIG. 1 is a diagram showing a configuration of one embodiment of an image processing system to which the present technology is applied. The image processing system 11 shown in FIG. 1 includes cameras 21-1 to 21-3 and an image processing apparatus 22.

The cameras 21-1 to 21-3 are, for example, imaging devices installed at predetermined places such as a studio, a conference room, and a room, and are devices for imaging performers. Here, the cameras 21-1 to 21-3 are described as cameras that capture one performer and capture the performer from different angles. The cameras 21-1 to 21-3 function as imaging devices that capture still images and moving images. Here, a case where a person is imaged by the cameras 21 and an image of the person is composed with another image is described as an example. However, the present technology can be applied to an object other than a person. In other words, a subject may be a person or an object.

In the following description, in a case where the cameras 21-1 to 21-3 do not need to be distinguished from each other, the cameras are simply described as the cameras 21. Other parts are described in the similar manner. Here, a case where three cameras 21-1 to 21-3 are installed is described as an example, but the present technology can be applied to a case where one or more cameras 21 are provided, and is not limited to a case where three cameras 21 are provided.

The image processing apparatus 22 acquires and processes images captured by the cameras 21-1 to 21-3. As is described later, the image processing apparatus 22 executes processing of generating a person crop panel including a performer from an image captured by the cameras 21, or generating an image obtained by composing the performer with a background image using the person crop panel.

The cameras 21 and the image processing apparatus 22 can be connected to each other by a cable such as High-Definition Multimedia Interface (HDMI) (registered trademark) or Serial Digital Interface (SDI). Furthermore, the cameras 21 and the image processing apparatus 22 may be connected via a wireless/wired network.

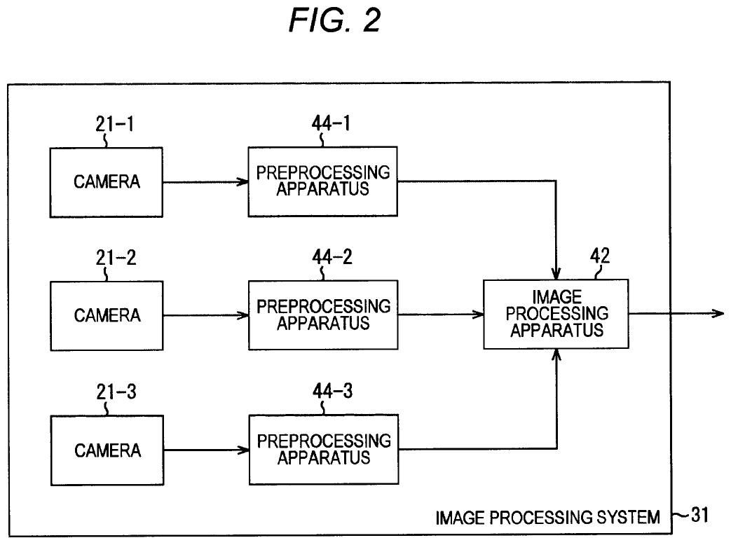

FIG. 2 is a diagram showing another configuration example of the image processing system. An image processing system 31 shown in FIG. 2 includes the cameras 21-1 to 21-3, preprocessing apparatuses 41-1 to 41-3, and an image processing apparatus 42.

The image processing system 31 shown in FIG. 2 is different from that in FIG. 1 in that the processing performed by the image processing apparatus 22 of the image processing system 11 shown in FIG. 1 is performed in a distributed manner by the preprocessing apparatuses 41 and the image processing apparatus 42. In other words, a part of the processing of the image processing apparatus 22 shown in FIG. 1 may be performed by the preprocessing apparatus 41 provided for each camera 21.

The preprocessing apparatus 41 can be configured, for example, to generate a person crop panel and supply the person crop panel to the image processing apparatus 42.

The camera 21 and the preprocessing apparatus 41, and the preprocessing apparatus 41 and the image processing apparatus 42 may be connected by a cable such as HDMI or SDI. Furthermore, the camera 21 and the preprocessing apparatus 41, and the preprocessing apparatus 41 and the image processing apparatus 42 may be connected via a wireless/wired network.

In the following, the description is continuously made in a case where the configuration of the image processing system 11 shown in FIG. 1 is described as an example.

<Arrangement of Camera>

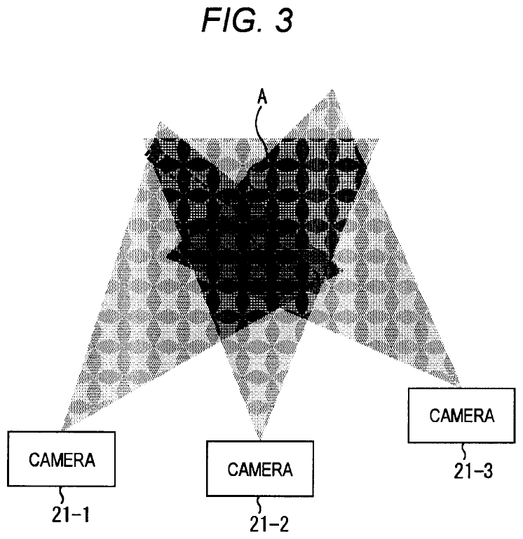

FIG. 3 is a diagram showing an arrangement example of the cameras 21 in the real space. In the real space, the cameras 21-1 to 21-3 are arranged at positions where a performer A can be imaged from different directions. In FIG. 3, the camera 21-1 is arranged at a position where the performer A is imaged from the left side. The camera 21-2 is arranged at a position where the performer A is imaged from the front side. The camera 21-3 is arranged at a position where the performer A is imaged from the right side.

In FIG. 3, an imaging range at a predetermined angle of view (the angle of view in the horizontal direction in FIG. 3) of each camera 21 is indicated by a triangular shape. In FIG. 3, the performer A is within a range that can be imaged by any camera 21 of the cameras 21-1 to 21-3. In the following description, a case where the cameras 21-1 to 21-3 are arranged in the positional relationship with each other as shown in FIG. 3 in the real space is described as an example.

As shown in FIG. 3, each of the cameras may be a camera 21 that is fixed at a predetermined position, or may be a camera 21 that moves. The term, the camera 21 moves, includes a case where the camera 21 itself moves, and a case where operations such as panning, tilting, and zooming is also included as moving.

<Configuration of Image Processing Apparatus>

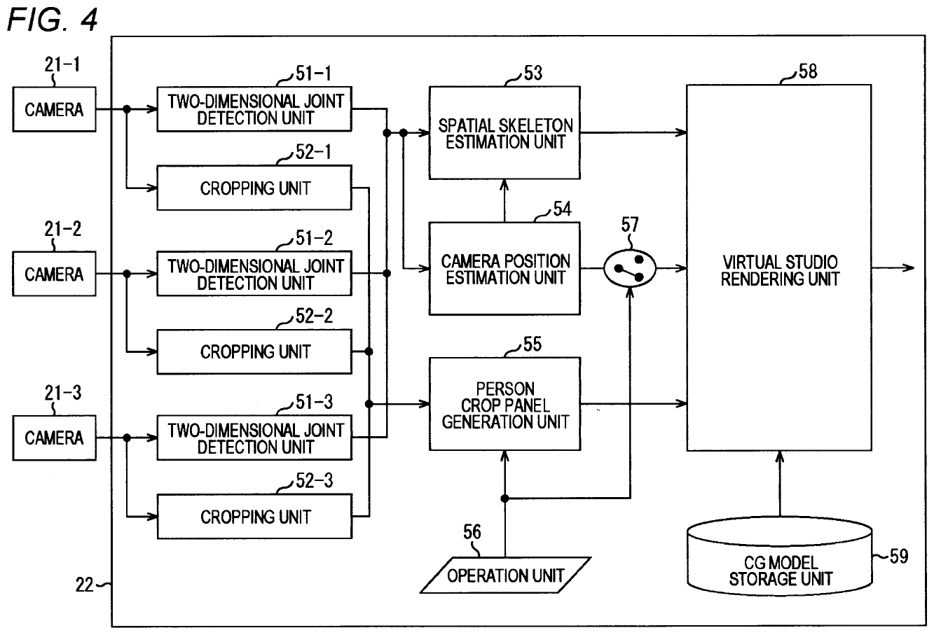

FIG. 4 is a diagram showing a configuration example of the image processing apparatus 22. The image processing apparatus 22 includes two-dimensional joint detection units 51-1 to 51-3, cropping units 52-1 to 52-3, a spatial skeleton estimation unit 53, a camera position estimation unit 54, a person crop panel generation unit 55, an operation unit 56, a switching unit 57, a virtual studio rendering unit 58, and a CG model storage unit 59.

The two-dimensional joint detection unit 51 and the cropping unit 52 are provided for each camera 21. In other words, the two-dimensional joint detection unit 51 and the cropping unit 52 are provided in the image processing apparatus 22 as many as the number of cameras 21. Note that one two-dimensional joint detection unit 51 and one cropping unit 52 may be provided for the plurality of cameras 21, and processing may be performed in a time division manner.

In a case where the preprocessing apparatus 41 is provided as in the image processing system 31 shown in FIG. 2, the preprocessing apparatus 41 can be provided with the two-dimensional joint detection unit 51 and the cropping unit 52.

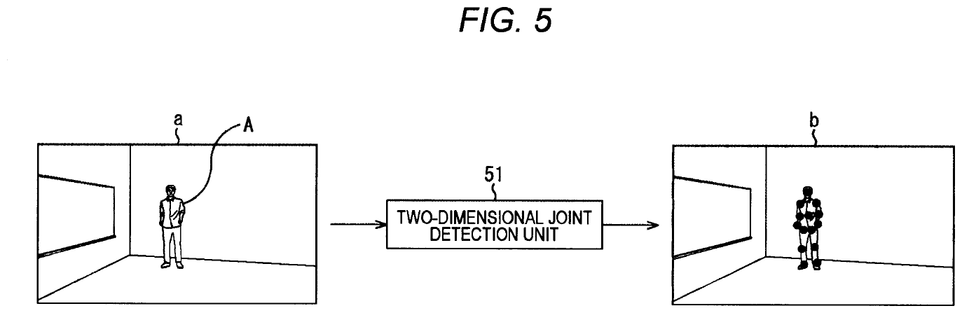

The video output from the camera 21 is supplied to each of the two-dimensional joint detection unit 51 and the cropping unit 52. The two-dimensional joint detection unit 51 detects joint positions of the performer A from the input image, and outputs information on the joint positions to the spatial skeleton estimation unit 53 and the camera position estimation unit 54. Processing of the two-dimensional joint detection unit 51 is described by exemplifying a case where an image as shown on the left side in FIG. 5 is input to the two-dimensional joint detection unit 51.

An image a shown on the left side in FIG. 5 is an image in which the performer A in the room is imaged in the vicinity of the center. Here, a case where portions having physical features of the performer A are detected is described as an example.

Examples of portions having physical features of a person (hereinafter, referred to as feature points as appropriate) include a left shoulder, a right shoulder, a left elbow, a right elbow, a left wrist, a right wrist, a neck portion, a left waist, a right waist, a left knee, a right knee, a left inguinal portion, a right inguinal portion, a left ankle, a right ankle, a right eye, a left eye, a nose, a mouth, a right ear, a left ear, and the like of a person. The two-dimensional joint detection unit 51 detects these portions as the feature points. Note that the portions described as the physical features are examples, and other portions, for example, portions such as a finger joint, a fingertip, and a top of the head may be detected instead of the above-described portions, or may be detected in addition to the above-described portions.

In an image b shown in the right diagram in FIG. 5, the feature points detected from the image a are indicated by black circles. In the image b, there are 14 feature points, which are the face (nose), the left shoulder, the right shoulder, the left elbow, the right elbow, the left wrist, the right wrist, the abdomen, the left inguinal portion, the right inguinal portion, the left knee, the right knee, the left ankle, and the right ankle.

The two-dimensional joint detection unit 51 analyzes the image from the camera 21 and detects the feature points of the person captured in the image. The detection of the feature points by the two-dimensional joint detection unit 51 may be performed by designation by a person or may be performed using a predetermined algorithm. As the predetermined algorithm, for example, a technique referred to as Open Pose or the like described in the following Document 1 can be applied.

Document 1 Zhe Cao and Tomas Simon and Shih-En Wei and Yaser Sheikh. Realtime Multi-Person 2D Pose Estimation using Part Affinity Fields. In CVPR, 2017.

The technique disclosed in Document 1 is a technique for estimating a posture of a person, and detects portions having physical features of the person as described above, for example, a joint, for estimating the posture. Other techniques other than Document 1 can be applied to the present technology, and the feature points can be detected by other methods.

In the technique disclosed in Document 1, simply described, joint positions are estimated from one image using deep learning, and a confidence map is obtained for each joint. For example, in a case where 18 joint positions are detected, 18 confidence maps are generated. Then, by joining the joints, posture information of the person is obtained.

In the two-dimensional joint detection unit 51, it is sufficient that the feature points, that is, in this case, the joint positions can be detected, and thus, it is sufficient that the processing up to this point is executed. The two-dimensional joint detection unit 51 outputs to the subsequent stage the detected feature points, that is, in this case, information regarding the two-dimensional joint positions of the performer A. The output information may be information of an image to which the detected feature points are added as in the image b in FIG. 5, or may be information of coordinates of each of the feature points. The coordinates are coordinates in the real space.

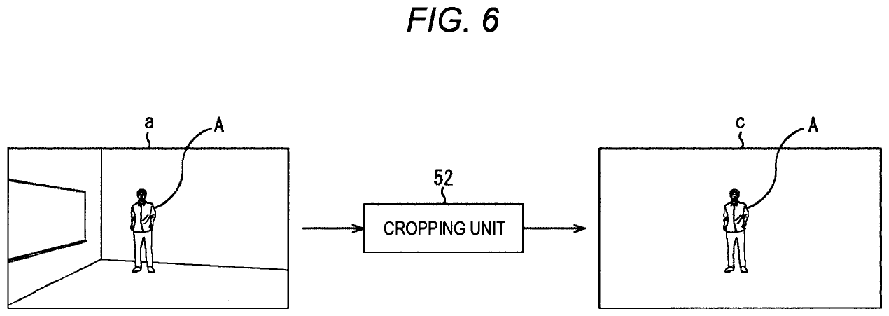

The image from the camera 21 is also supplied to the cropping unit 52. The cropping unit 52 extracts the performer A from the image from the camera 21. For example, in a case where the image a as shown in the left diagram in FIG. 6 is input to the cropping unit 52, an image c as shown in the right diagram in FIG. 6 is output. The image a is the same as the image input to the two-dimensional joint detection unit 51, and is the image a shown in the left diagram in FIG. 5.

The cropping unit 52 separates the background and a region of the person from each other in the input image a using the background subtraction method to generate the image c in which the performer A is cropped. The image c is appropriately described as a cropped image. The cropping unit 52 may generate the cropped image c by processing using machine learning. Semantic segmentation can be used in a case where the cropping using machine learning is performed.

In a case where the image c is generated using the semantic segmentation, the cropping unit 52 classifies the type of the subject in units of pixels by semantic segmentation on the basis of the RGB image (image a in FIG. 6) captured by the camera 21 using a learned neural network stored in advance in a storage unit (not illustrated) by learning.

In a case where the performer A is extracted by the cropping unit 52, a technique of chroma key composition may be used. The chroma key composition technique can generate a moving image including a region where the performer A is imaged by performing imaging with a specific color such as the color of a green backdrop or a blue backdrop as a background and removing the background by making a component of the specific color transparent.

It is also possible to configure such that the camera 21 captures an image with a specific color such as the color of a green backdrop or a blue backdrop as a background, and the cropping unit 52 processes the captured image to generate the cropped image c from which the performer A has been extracted.

The present technology can also be applied to a virtual studio using a mobile camera by using, for example, simultaneous localization and mapping (SLAM), a robot camera platform, and a pan-tilt-zoom (PTZ) sensor. In a case where the present technology is applied to a virtual studio by such a moving camera, the position and the direction of the camera 21 are estimated and acquired every moment.

In the cropping unit 52, a person region is extracted using a technique such as the semantic segmentation. Because the semantic segmentation is a technique that can separate a background and a person from each other even when the background is not fixed, the technique can be applied as a cropping method by the cropping unit 52 when a virtual studio is realized by using a moving camera.

The cropping unit 52 analyzes the input image and generates the cropped image c in which a portion other than the person (performer A), in other words, the background portion is set to transparent. For example, the cropping unit 52 generates texture data in which the cropped image c is represented by four channels RGBA, where RGB channels respectively represents the colors of the image of the performer A and an Alpha (A) channel represents the transparency and the transparency is set to fully transparent (0.0 in a numerical value).

The image processing system 11 shown in FIG. 4 is referred to again. In each of the two-dimensional joint detection units 51-1 to 51-3, the images from the cameras 21-1 to 21-3 are processed, and information regarding the two-dimensional joint positions is supplied to the spatial skeleton estimation unit 53 and the camera position estimation unit 54. Similarly, in each of the cropping units 52-1 to 52-3, the images from the cameras 21-1 to 21-3 are processed, and the cropped image related to the performer A is supplied to the person crop panel generation unit

The two-dimensional joint detection unit 51 and the cropping unit 52 are portions that perform two-dimensional processing, and the processing after the processing in the spatial skeleton estimation unit 53 is a portion that performs three-dimensional processing. In a case where the preprocessing apparatus 41 and the image processing apparatus 42 perform distributed processing as in the image processing system 31 shown in FIG. 2, the preprocessing apparatus 41 can include the two-dimensional joint detection unit 51 and the cropping unit 52, and the image processing apparatus 42 can be configured to perform processing by the spatial skeleton estimation unit 53 and processing thereafter. In other words, the preprocessing apparatus 41 can be used as an apparatus that is provided in each camera 21 and performs the two-dimensional processing on an image from each camera 21, and the image processing apparatus 42 can be used as an apparatus that performs the three-dimensional processing.

In addition to the information regarding the two-dimensional joint positions from the two-dimensional joint detection unit 51, the spatial skeleton estimation unit 53 is supplied with information regarding the position, the orientation, and the angle of view of each camera 21 estimated from the camera position estimation unit 54. That is, the spatial skeleton estimation unit 53 is supplied with joint information of the performer A estimated from the images captured by the cameras 21-1 to 21-3, and information regarding the position, the orientation, and the angle of view of each camera 21 in the real space of the cameras 21-1 to 21-3 from the camera position estimation unit 54.

The spatial skeleton estimation unit 53 estimates the position of the performer A in the three-dimensional space (real space) by applying the triangulation method using these pieces of information. The position of the performer A can be the positions of the joints extracted as the joint positions of the performer A, in other words, the positions of the feature points described above in the real space. Instead of obtaining the positions in the real space for all the detected feature points, the position in the real space of a specific feature point, for example, a feature point detected as the position of the face may be obtained.

Note that, here, the position of the subject is estimated by the spatial skeleton estimation unit 53 from the position information of the cameras 21 and the features of the subject (for example, information on the joint positions of the subject), but the position of the subject may be estimated by another method. For example, the subject may hold a position measuring device that can measure the position of the subject such as a global positioning system (GPS), and the position of the subject may be estimated from the position information obtained from the position measuring device.

The camera position estimation unit 54 estimates the positions of the cameras 21-1 to 21-3 in the real space. For the estimation of the position, a method can be used in which a board called a dedicated calibration board on which a pattern having a fixed shape and size is printed is used, the calibration board is simultaneously imaged by the cameras 21-1 to 21-3, and analysis is performed using the images captured by the cameras 21 to calculate the positional relationship of the cameras 21.

A method using the feature points can also be applied to the estimation of the position. The camera position estimation unit 54 is supplied with information on the joint positions of the performer A, that is, information on the feature points extracted from the performer A from the two-dimensional joint detection unit 51. As described above, these feature points are, for example, the left shoulder, the right shoulder, the left elbow, the right elbow, the left wrist, the right wrist, the neck portion, the left inguinal portion, the right inguinal portion, the left knee, the right knee, the left ankle, and the right ankle of a person.

The position of the cameras 21 can be calculated using these feature points. This calculation method is briefly described in addition. The camera position estimation unit 54 calculates parameters called external parameters as a relative position between the cameras 21-1 to 21-3. The external parameters of the camera 21, generally referred to as external parameters of a camera, are rotation and translation (a rotation vector and a translation vector). The rotation vector represents the orientation of the camera 21, and the translation vector represents the position information of the camera 21. Regarding the external parameters, the origin of the coordinate system of the camera 21 is at the optical center, and an image plane is defined by the X axis and the Y axis.

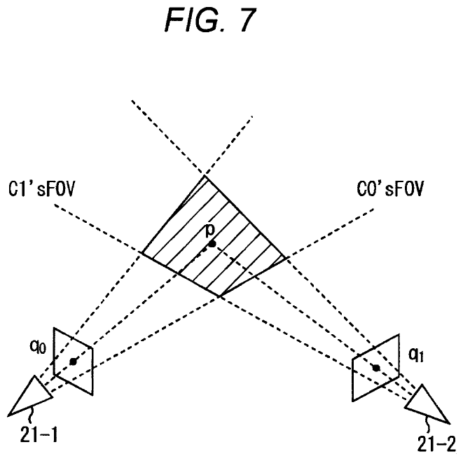

The external parameter can be obtained using an algorithm called the eight-point algorithm. The eight-point algorithm is additionally described. Assuming that three-dimensional point p exists in the three-dimensional space as shown in FIG. 7, and projection points on the image plane when the three-dimensional point p is imaged by the camera 21-1 and the camera 21-2 are q0 and q1, respectively, the following relational formula (1) holds between these points.

### [Mathematical Formula 1]

q₀^{T}Fq₁=0 (1)

In the formula (1), F is a fundamental matrix. The fundamental matrix F can be obtained by preparing eight or more pairs of coordinate values such as the above (q0, q1) obtained when a certain three-dimensional point is imaged by each camera 21 and applying the eight-point algorithm or the like.

Moreover, using internal parameters (K0, K1) that are parameters unique to the camera 21 such as a focal length and an image center, and an essential matrix (E), the formula (1) can be developed as the following formula (2). Further, the formula (2) can be developed to the formula (3).

### [Mathematical Formula 2]

q₀^{T}K₀^{-T}EK₁q₁= (2)

[Mathematical formula 3]

E=K₀^{T}FK₁⁻¹ (3)

In a case where the internal parameter (K0, K1) is known, the E matrix can be obtained from the set of corresponding points described above. Moreover, this E matrix can be decomposed into external parameters by performing the singular value decomposition. Furthermore, when vectors representing the point p in the coordinate system of the imaging device are p0 and p1, the essential matrix E satisfies the following formula (4).

### [Mathematical Formula 4]

p₀^{T}Ep₁=0 (4)

At this time, in a case where the camera 21 is a perspective projection imaging device, the following formula (5) holds.

### [Mathematical Formula 5]

p₀˜K₀⁻q₀, p₁˜K⁻¹p₁ (5)

At this time, the E matrix can be obtained by applying the eight-point algorithm to the pair of (p0, p1) or the pair of (q0, q1). From the above, the fundamental matrix and the external parameters can be obtained from a set of corresponding points obtained between images captured by the plurality of cameras 21.

The camera position estimation unit 54 calculates the external parameters by performing processing to which such an eight-point algorithm is applied. In the above description, the eight sets of corresponding points used in the eight-point algorithm are sets of feature points detected as the positions of physical features of a person. The feature points detected as the positions of the physical features of the person is information supplied from the two-dimensional joint detection unit 51.

For example, the position of the right shoulder of the performer A supplied from the two-dimensional joint detection unit 51-1 and the position of the right shoulder of the performer A supplied from the two-dimensional joint detection unit 51-2 are used as one pair of feature points. By generating at least eight pairs of corresponding points with the same joint as a pair, the relative position between the camera 21-1 and the camera 21-2 are obtained as described above.

Similarly, the relative position between the camera 21-1 and the camera 21-3 and the relative position between the camera 21-2 and the camera 21-3 can be obtained. The positions of the three cameras 21-1 to 21-3 can be obtained, for example, by using the position of the camera 21-1 as a reference and obtaining the relative position with respect to the camera 21-1 set as the reference.

For example, in a case where the cameras 21-1 to 21-3 are arranged in the real space as shown in FIG. 3, the camera position estimation unit 54 generates information regarding the relative position of the camera 21-2 with respect to the camera 21-1 and information regarding the relative position of the camera 21-3 with respect to the camera 21-1. The camera position estimation unit 54 detects the positional relationship between the cameras 21-1 to 21-3 as shown in FIG. 3 by integrating the positional information of the camera 21-2 and the camera 21-3 with the camera 21-1 set as a reference.

In this manner, the camera position estimation unit 54 uses the position of one camera 21 among the plurality of cameras 21 as a reference, and detects and integrates the relative positional relationship between the camera 21 set as a reference and the other cameras 21, in order to detect the positional relationship among the plurality of cameras 21.

The method of detecting the position of each of the cameras 21 using the information of the feature points (joint positions) detected from the performer A can also be applied to a case where the camera 21 moves.

Here, a case where the physical features of the person is detected as the feature points and the position of the camera 21 is estimated using the feature points has been described as an example, but the feature points other than the physical features of the person may be used as the feature points used to estimate the position of the camera 21. For example, the feature points may be detected from a specific object in a room or an object such as a building, a signboard, or a tree in the case of outdoors, and the position of the camera 21 may be estimated using the feature points thereof.

The processing by the camera position estimation unit 54 is performed for each frame in the case of the moving camera 21 (performed every time one clip image is generated), and is sufficient to be performed once at the beginning in the case of the fixed camera 21.

Information regarding the position, the orientation, and the angle of view of the camera 21 estimated by the camera position estimation unit 54 is supplied to the spatial skeleton estimation unit 53. Note that the information regarding the angle of view may be supplied from the camera 21 via the two-dimensional joint detection unit 51, or may be directly supplied from the camera 21 to the camera position estimation unit 54.

The information regarding the position of the camera 21 estimated by the camera position estimation unit 54 is also supplied to the switching unit 57. The switching unit 57 selects information to be supplied from the camera position estimation unit 54 to the virtual studio rendering unit 58 in accordance with an instruction from the operation unit 56. Specifically, the switching unit 57 is supplied with, from the operation unit 56, information regarding the camera 21 capturing the performer A to be combined with the CG as the composite video among the cameras 21-1 to 21-2. The switching unit 57 performs control such that information regarding the camera 21 is supplied to the virtual studio rendering unit 58, the camera 21 having captured the performer A to be composed on the basis of the information from the operation unit 56.

The operation unit 56 is a function of receiving an operation from a user, and includes, for example, a keyboard, a mouse, a touch panel, and the like. The user who uses the image processing apparatus 22, in other words, an editor who edits the composite video operates the operation unit 56, selects the camera 21 capturing the performer A to be composed with the CG as the composite video, and inputs information regarding the selected camera 21 (hereinafter, described as the selected camera 21). From the operation unit 56, information (hereinafter, described as a selected camera ID) for identifying the selected camera 21 is output to the switching unit 57 and the person crop panel generation unit 55.

The person crop panel generation unit 55 generates a panel which is described as a person crop panel herein. Cropped images are supplied from the cropping units 52-1 to 52-3 to the person crop panel generation unit 55. The person crop panel generation unit 55 selects a cropped image generated from an image captured by the camera 21 identified by the selected camera ID, from among the supplied cropped images.

The person crop panel generation unit 55 generates the person crop panel by using the selected cropped image. The generated person crop panel is supplied to the virtual studio rendering unit 58.

Note that, although it has been described here that the information regarding the camera 21 selected by the selected camera ID and the person crop panel are supplied to the virtual studio rendering unit 58, the information regarding the camera 21 corresponding to the selected camera ID and the person crop panel may be selected on the virtual studio rendering unit 58 side.

In the case of such a configuration, the information regarding the cameras 21-1 to 21-3 is supplied from the camera position estimation unit 54 to the virtual studio rendering unit 58. The person crop panels generated from the images from the cameras 21-1 to 21-3 are supplied from the person crop panel generation unit 55 to the virtual studio rendering unit 58. The virtual studio rendering unit 58 selects one piece of information from the information regarding the plurality of cameras 21 on the basis of the selected camera ID supplied from the operation unit 56, and selects one person crop panel from the plurality of person crop panels.

In this manner, the virtual studio rendering unit 58 may be configured to select the camera information and the person crop panel.

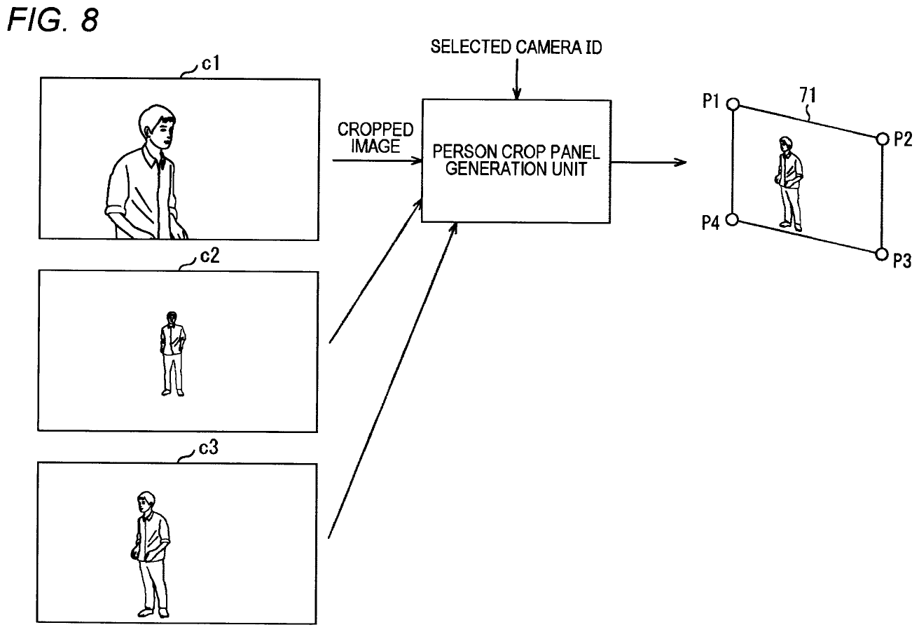

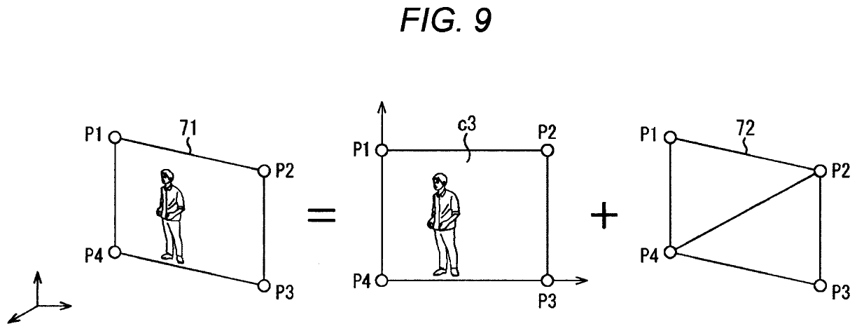

Additional description is made on the generation of the person crop panel performed by the person crop panel generation unit 55 with reference to FIGS. 8 and 9. The person crop panel is subject information (model) in the three-dimensional space obtained by processing a captured image captured by the camera 21, and is generated by the following processing.

The person crop panel generation unit 55 is supplied with cropped images c1 to c3 from the cropping units 52-1 to 52-3. The person crop panel generation unit 55 selects, as a processing target, the cropped image c corresponding to the selected camera ID supplied from the operation unit 56.

Here, a case where the person crop panel generation unit 55 is configured to select and process one cropped image c as a processing target is described as an example. As described above, in a case where one cropped image c is set as a processing target, the image processing apparatus 22 may be configured such that the number of cropped images c supplied to the person crop panel generation unit 55 is one.

For example, a switching unit having a function equivalent to that of the switching unit 57 may be provided between the cropping unit 52 and the person crop panel generation unit 55, the switching unit 57 having a function of selecting an image from the cropping units 52-1 to 52-3 according to the selected camera ID from the operation unit 56 and supplying the image to the person crop panel generation unit 55.

The example shown in FIG. 8 shows an example in which the cropped image c3 supplied from the cropping unit 52-3 is selected. As shown in FIG. 9, a person crop panel 71 generated by the person crop panel generation unit 55 is an object generated in the three-dimensional space (space of a virtual studio) including a cropped image and a polygon.

As shown in FIG. 9, the polygon is a four-vertex planar polygon 72. The planar polygon 72 is a polygon represented by a plane having four vertices including a vertex P1, a vertex P2, a vertex P3, and a vertex P4. The four vertices have coordinates of four vertices of the cropped image. In the example shown in FIG. 9, because the cropped image c3 is selected, four vertices of the cropped image c3 are set as four vertices of the planar polygon 72. Four vertices of the cropped image c3 are four vertices of the image captured by camera 21-3.

The person crop panel generation unit 55 generates the person crop panel 71 by pasting the cropped image c3 on the planar polygon 72. The cropped image c3 is an image in which a portion other than the person (performer A), in other words, the background portion is set to transparent. For example, the cropped image c3 is represented by four channels RGBA, where RGB channels respectively represents the colors of the image of the performer A and an Alpha (A) channel represents the transparency and the transparency is set to fully transparent (0.0 in a numerical value).

Here, the description is continued by exemplifying a case where the cropped image c generated by the cropping unit 52 and supplied to the person crop panel generation unit 55 is texture data with the transparent channel, and the background is an image set to be completely transparent by the transparent channel.

The cropped image c corresponds to an image generally called a mask image, a silhouette image, or the like, and is an image of a two-dimensional plane. The person crop panel 71 is an image obtained by pasting such a cropped image c on the planar polygon 72. In other words, the person crop panel 71 is data obtained by adding the data of the planar polygon 72 to the image corresponding to the mask image or the silhouette image.

The person crop panel 71 can be realized while the live-action video is treated as a texture with pixel data kept as it is. For example, in the case of a technology in which the shape of a person is represented by a polygon and combined with a CG image, there is a possibility that the fineness and the like of the finally generated image are deteriorated due to the modeling accuracy of the polygon of the shape of the person. According to the person crop panel 71, the shape of a person is not represented by a polygon, but the live-action video can be handled as a texture with pixel data kept as it is. Therefore, for example, a fine image (video) can be generated even in a person boundary region.

Reference is made again to FIG. 3. Conceptually, the person crop panel 71 can be considered as a cross-sectional view obtained by cutting a space in a cross section at a position where the performer A is present as indicated by a dotted quadrangle in FIG. 3. In FIG. 3, an image in which a cross section at a position where the performer A is present is cut out to the full imaging range among the image captured by the camera 21-1, and a portion other than the performer A is in a transparent state can be regarded as the person crop panel 71.

The generated person crop panel 71 generated by the person crop panel generation unit 55 is supplied to the virtual studio rendering unit 58.

Note that, although the case where the person crop panel generation unit 55 generates one piece of the person crop panel 71 on the basis of the selected camera ID has been described as an example, as described above, the person crop panel generation unit 55 may be configured to generate a plurality of the person crop panels 71 and supply the same to the virtual studio rendering unit 58.

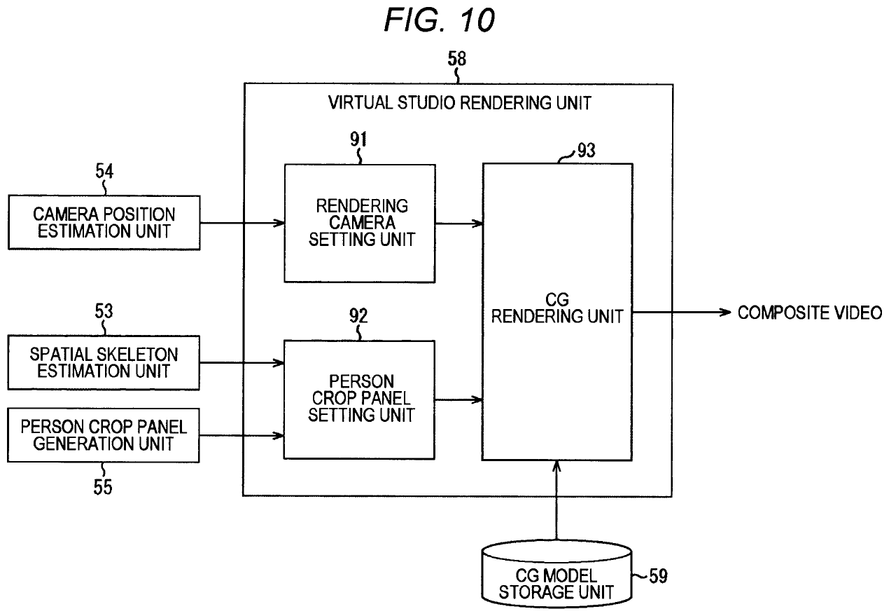

FIG. 10 is a diagram showing a configuration example of the virtual studio rendering unit 58. The virtual studio rendering unit 58 includes a rendering camera setting unit 91, a person crop panel setting unit 92, and a CG rendering unit 93. A CG model rendered by the CG rendering unit 93 is stored in the CG model storage unit 59.

Here, the description is continued assuming that the CG model is rendered, but the rendering target is not limited to the CG model, and may be a live-action video.

Information such as the position, the orientation, and the angle of view of the camera 21 corresponding to the selected camera ID is supplied from the camera position estimation unit 54 to the rendering camera setting unit 91. The person crop panel setting unit 92 is supplied with three-dimensional spatial skeleton information of the performer A from the spatial skeleton estimation unit 53 and supplied with the person crop panel 71 corresponding to the selected camera ID from the person crop panel generation unit 55.

The virtual studio rendering unit 58 is a unit that generates the final composite video of the virtual studio. Processing of rendering and composition of the CG model with the live-action video (cropped image) of the person region cropped from the live-action video of the selected camera 21 is executed, the CG model having the angle, the perspective, and the framing matched with the live-action video.

The virtual studio rendering unit 58 sets a rendering camera in the virtual studio that is a virtual space, installs the person crop panel 71 in a CG studio model, and performs the CG rendering to generate the composite video.

The rendering camera setting unit 91 installs the rendering camera corresponding to the camera 21 in the real space at a position in the virtual studio corresponding to the position at which the camera 21 is located in the real space. Specifically, the rendering camera setting unit 91 sets the position, the orientation, and the angle of view of the camera for rendering such that the position, the orientation, and the angle of view of the camera 21 obtained as the position information of the camera 21 supplied from the camera position estimation unit 54 match the coordinate system of the virtual studio model of the CG. The rendering camera is a virtual camera installed in the virtual studio, and is a camera corresponding to the camera 21 installed in the real space.

By matching the position of the camera 21 in the real space with the position of the camera in the virtual studio, the virtual CG studio and the CG object can be rendered in the same orientation and the perspective as those of the live-action camera. In this way, the virtual studio can be easily composed with the live-action image.

The person crop panel setting unit 92 installs the person crop panel 71 in the virtual studio. The person crop panel setting unit 92 obtains a position where the performer A is present in the virtual studio by using the information on the position where the performer A is present in the real space and supplied from the spatial skeleton estimation unit 53, and installs the person crop panel 71 at the obtained position. The person crop panel 71 is installed so as to fill the angle of view of the rendering camera and face the rendering camera.

The rendering camera is installed at a correct position in the virtual studio by the rendering camera setting unit 91. Then, the quadrangular polygon to which the live-action texture is pasted, that is, the person crop panel 71 is installed at a position that faces the rendering camera over the full angle of view and coincides with the spatial skeleton position.

On the person crop panel 71, the CG rendering unit 93 renders a CG image or renders an object in a region set to transparent. The CG rendering unit 93 reads the image to be rendered from the CG model storage unit 59.

The CG rendering unit 93 composes the person crop panel 71 with the background and the foreground of the virtual studio captured by the rendering camera.

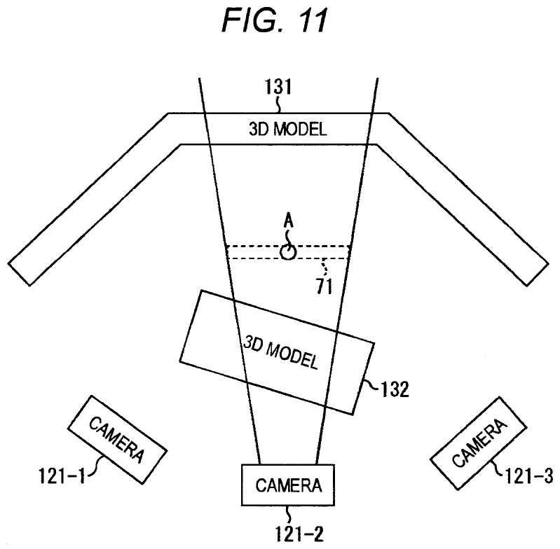

The processing of the virtual studio rendering unit 58 is further described with reference to FIG. 11. FIG. 11 is an overhead view showing a configuration of an example of the virtual studio. In the virtual studio, a 3D model 131 serving as a background such as a wall or a window, and a 3D model 132 such as a desk or a flower are arranged. Rendering cameras 121-1 to 121-3 are arranged in the virtual studio.

Although FIG. 11 shows an example in which the rendering cameras 121-1 to 121-3 are arranged, the rendering camera 121 corresponding to the camera 21 selected by the selected camera ID is arranged. This is applied similarly in the drawing used in the following description. Furthermore, the description is continued assuming that the rendering camera 121-1 corresponds to the camera 21-1, the rendering camera 121-2 corresponds to the camera 21-2, and the rendering camera 121-3 corresponds to the camera 21-3.

FIG. 11 shows the case where the camera 21-2 (rendering camera 121-2) are selected by the selected camera ID, and shows the imaging range (angle of view) of the rendering camera 121-2.

The rendering camera 121 is installed at a corresponding position in the virtual studio by the rendering camera setting unit 91 on the basis of the position, the orientation, the angle of view, and the like of the camera 21 in the real space estimated by the camera position estimation unit 54.

The person crop panel setting unit 92 sets the position of the virtual studio rendering corresponding to the position of the performer A in the real space supplied from the spatial skeleton estimation unit 53. The position of the performer A shown in FIG. 11 indicates the position of the performer A in the virtual studio. The person crop panel 71 is installed at the position of the performer A.

The person crop panel 71 is installed so as to fill the angle of view of the rendering camera 121-2 and face the rendering camera 121-2. In the virtual studio, the 3D model 132 is arranged between the rendering camera 121-2 and the person crop panel 71. By installing the person crop panel 71 so as to coincide with the spatial skeleton position of the performer A, in other words, by setting the position of the person crop panel 71 in the depth direction so as to coincide with the spatial skeleton position in the virtual studio, the positional relationship (anteroposterior relationship) among the rendering camera 121-2, the person crop panel 71, and the 3D model 132 can be grasped.

Therefore, in the case of a situation as shown in FIG. 11, rendering can be performed by the CG rendering unit 93 assuming that the 3D model 132 is in front of the person crop panel 71 (performer A), in other words, on the camera 121-2 side. In this case, the 3D model 132 is rendered as the foreground of the performer A, and the 3D model 131 is rendered as the background.

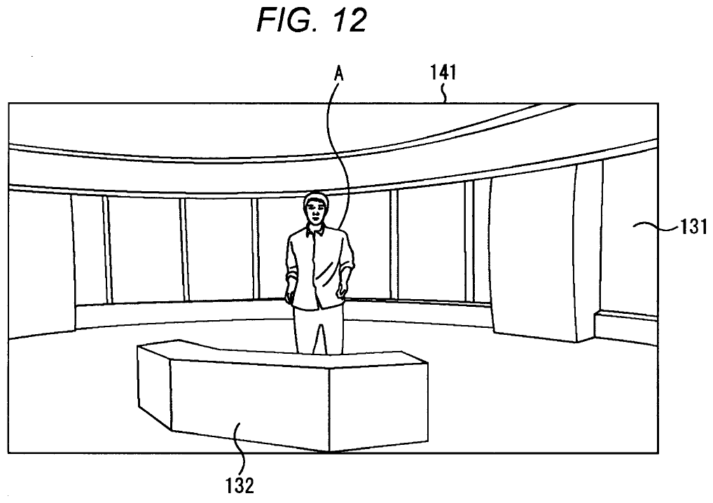

FIG. 12 shows an example of a composite video (composite image) generated by the virtual studio rendering unit 58 in the virtual studio as shown in FIG. 11. The rendering camera 121-2 corresponds to the camera 21-2, and the image generated by the cropping unit 52 (FIG. 4) from the image captured by the camera 21-2 is the cropped image c2 (FIG. 8).

Referring to FIG. 8 again, the cropped image c2 is an image in which the performer A is present near the center of the screen. By having the person crop panel 71 generated from such a cropped image c2, installed in the virtual studio, and rendered with the CG image, the image as shown in FIG. 12 is generated. As shown in FIG. 12, a composite image 141 is an image in which the performer A is projected near the center and the 3D model 131 such as a wall or a window is composed on the background of the performer A.

As described with reference to FIG. 11, the 3D model 132 is present between the rendering camera 121-2 and the performer A. Here, the description is continued assuming that the 3D model 132 is a desk. As shown in FIG. 12, a desk is displayed as the 3D model 132 in front of the performer A shown in the composite image 141. Because the desk is in front of the performer A, a portion below the knee of the performer A is hidden behind the desk and is not displayed.

As described above, the composite image in which the anteroposterior relationship among the performer A, the 3D model 131, and the 3D model 132 is accurately grasped is generated.

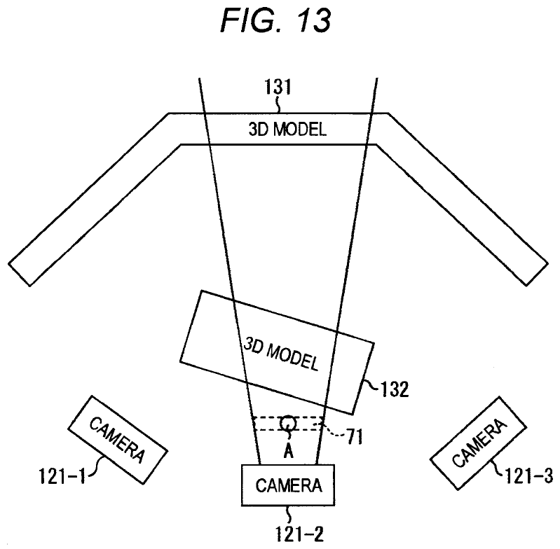

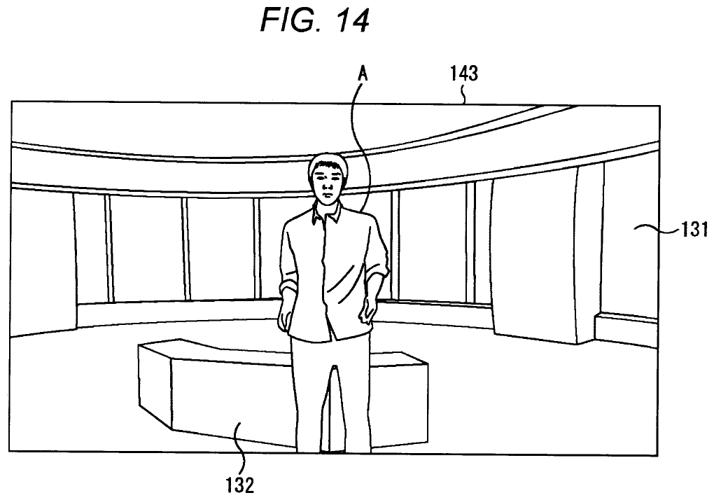

A case is assumed in which the performer A approaches the camera 21-2 side in the real space. The positional relationship in the virtual studio is represented as shown in FIG. 13. As shown in FIG. 13, in a case where the person A (person crop panel 71) is positioned between the rendering camera 121-2 and the 3D model 132, a composite image as shown in FIG. 14 is generated.

The composite image 143 shown in FIG. 14 is an image in which the performer A is positioned near the center of the screen and positioned in front of the desk as the 3D model 132.

As described above, even if the performer A moves around the desk being the 3D model 132, the anteroposterior relationship between the performer A and the desk can be prevented from collapsing. Therefore, a range in which the performer A can move in the real space can be expanded.

In a case where the performer A is located at the position of the desk being the 3D model 132, the positional relationship is such that the person crop panel 71 is in the 3D model 132. Even in such a case, an image generated as the composite image is an image close to the composite image 141 as shown in FIG. 12. Because the 3D model 132 is positioned nearer than the position of the person crop panel 71, the picture has the desk in front of the performer A.

However, because there is a possibility that the picture has a slight unnatural appearance, for example, the position of the desk of the 3D model 132 is marked on the floor of the real space or the like, and the performer A is asked to keep the eyes on the mark on the floor of the real space while moving so as not to enter the desk in the virtual studio. In this way, it is possible to further reduce the possibility that a picture having the unnatural appearance is provided as a composite image is further reduced.

As described above, the person crop panel 71 is installed so as to fill the angle of view of the rendering camera 121 and face the rendering camera. By installing the person crop panel 71 in this manner, the occurrence of jitter can be prevented even when the performer A moves. For example, due to the accuracy of spatial skeleton estimation and the influence of temporal flutter (jitter), there is a possibility that the composite video becomes the one in which the image of the performer A is shaken when the performer A moves.

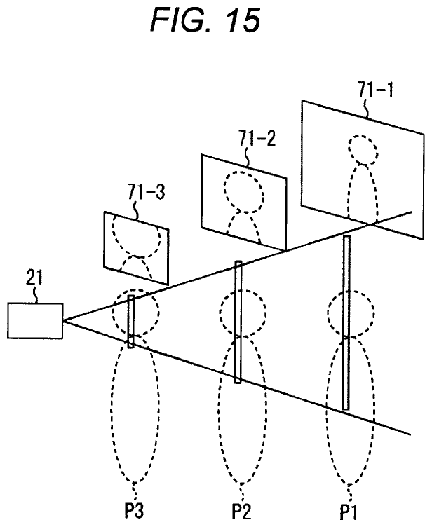

As shown in FIG. 15, because the person crop panel 71 is installed so as to fill the angle of view of the rendering camera 121 and face the camera 21, in a case where the performer A approaches or moves away from the camera, the generated person crop panel 71 is an enlarged or reduced panel.

For example, the person crop panels 71 generated when the performer A located at a position P1 far from the camera 21, an intermediate position P2, and a close position P3 are a person crop panel 71-1, a person crop panel 71-2, and a person crop panel 71-3, respectively. The sizes of the person crop panel 71 are the person crop panel 71-1>the person crop panel 71-2>the person crop panel 71-3.

As described above, because the person crop panel 71 is generated by performing similarity enlargement or similarity reduction according to the depth distance, the influence of jitter can be separated and eliminated from the quality of the finally generated composite image (composite video).

According to the present technology, the composite image can be generated in consideration of the anteroposterior relationship with a three-dimensional object such as a desk, and a range in which the performer can move around can be expanded. The person crop panel can be completely matched with the perspective deformation due to the forward and backward movement of the live-action image. The occurrence of blurring of the video due to the position estimation accuracy and the jitter can be suppressed. Even if an error in positional accuracy or jitter is large, the image can be prevented from blurring.

Because the processing described above only involves changing of the positions of the four vertices of the quadrangular polygon at the time of rendering by a graphics processing unit (GPU), the calculation cost can be reduced.

The virtual studio rendering processing can be realized in the category of handling polygon rendering of general computer graphics, in other words, hardware that excels in CG rendering such as a GPU can be used as it is.

In the above example, the case where the performer A moves has been described as an example, but a similar effect can be obtained in a case where the camera 21 moves. Therefore, the camera 21 arranged in the real space can be moved by panning, tilting, zooming, and the like, and even a video accompanied by such movement can generate a composite video that can obtain the above-described effect.

According to the present technology, a desired image can be obtained by moving the position of the rendering camera 121 in the virtual studio. Because the person crop panel 71 faces the rendering camera 121, for example, even if the rendering camera 121 is moved in the front and back direction (depth direction), distortion can be prevented from standing out. Therefore, even if the rendering camera 121 is moved, a desired image can be obtained without the image quality being deteriorated. A simple viewpoint movement can be realized by moving the rendering camera 121.

In the above description, the case where the image captured by the rendering camera 121-2 is processed has been described, but the case where the image captured by the rendering camera 121-1 or the rendering camera 121-3 is processed if described below.

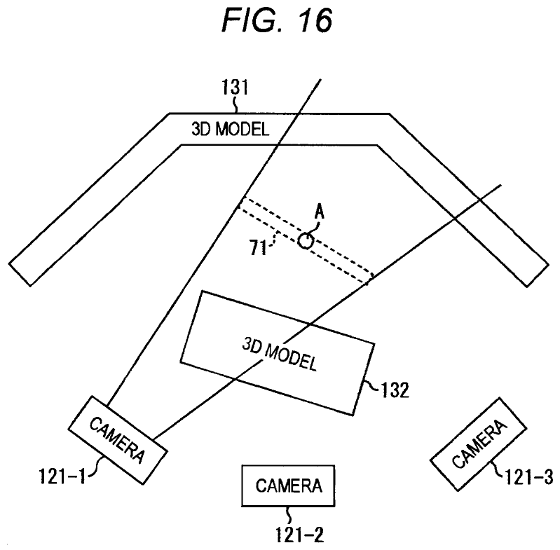

FIG. 16 is an overhead view of the virtual studio when the rendering camera 121-1 is selected as the selected camera. The positions of the virtual studio and the performer A shown in FIG. 16 are basically similar to those in the situation shown in FIG. 11.

The cropped image generated from the image captured by the camera 121-1 is, for example, the cropped image c1 shown in FIG. 8. The cropped image c1 is an image obtained by imaging the upper body of the performer 1A from the right side of the performer A. The person crop panel 71 generated from the cropped image c1 is installed at the position of the performer A in the virtual studio estimated by the spatial skeleton estimation unit 53. As in the case described above, the installation is made in the size that fills the angle of view of the rendering camera 121-1 and in a direction facing the rendering camera 121-1.

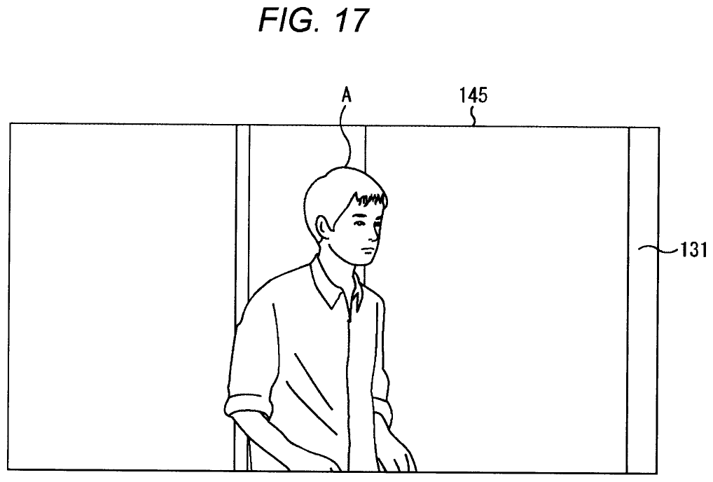

In the case of such a state, the processing of the virtual studio rendering unit 58 is executed to generate a composite image 145 as shown in FIG. 17. The composite image 145 shown in FIG. 17 is an image in which the upper body of the performer A is composed with a wall, a window, or the like indicated by the 3D model 131 on the background of the performer A. The desk, which is the 3D model 132, is not included within the vertical angle of view (within the imaging range) of the rendering camera 121-1, and thus is not displayed in the composite image 145.

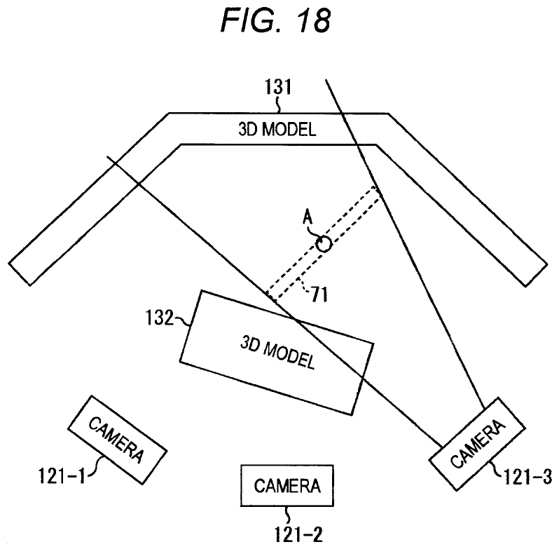

FIG. 18 is an overhead view of the virtual studio when the rendering camera 121-3 is selected as the selected camera. The positions of the virtual studio and the performer A shown in FIG. 18 are basically similar to those in the situation shown in FIG. 11.

The cropped image generated from the image captured by the rendering camera 121-3 is, for example, the cropped image c3 shown in FIG. 8. The cropped image c3 is an image obtained by imaging the whole body of the performer 1A from the left side of the performer A. The person crop panel 71 generated from the cropped image c3 is installed at the position of the performer A in the virtual studio estimated by the spatial skeleton estimation unit 53. As in the case described above, the installation is made in the size that fills the angle of view of the rendering camera 121-3 and in a direction facing the rendering camera 121-3.

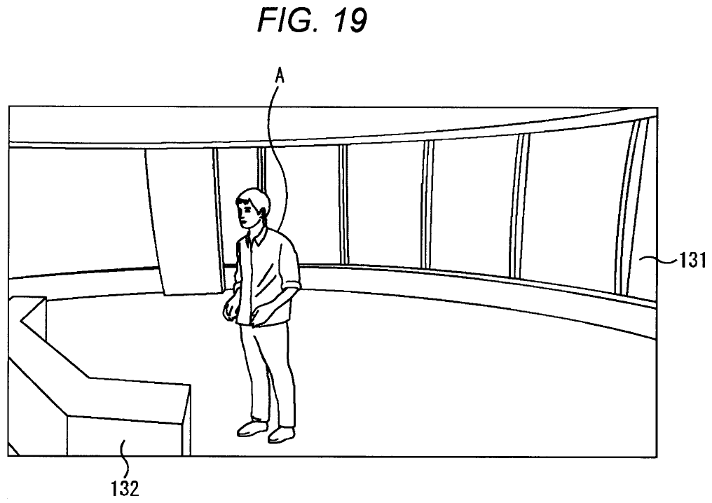

In the case of such a state, the processing of the virtual studio rendering unit 58 is executed to generate a composite image 147 as shown in FIG. 19. The composite image 147 shown in FIG. 19 is an image in which the whole body of the performer A is composed with a wall, a window, or the like indicated by the 3D model 131 on the background of the performer A and with a part of the desk indicated by the 3D model on the left side in the drawing.

In this manner, different composite images are generated depending on which imaging camera 21 the image is captured. In the above example, the case where one camera 21 is selected and only the image captured by the selected camera 21 is used as the composite image has been described as an example. However, a configuration may be employed in which images captured by the respective cameras 21 are processed to generate respective composite images, and the composite images are recorded.

<Processing of Image Processing Apparatus>

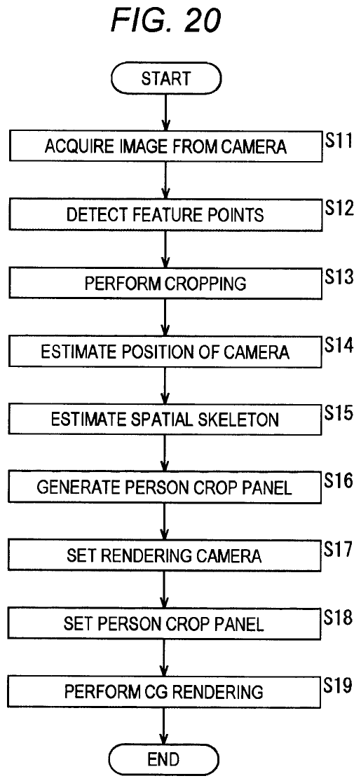

Referring to a flowchart in FIG. 20, additional description is made on processing of the image processing apparatus 22. Description overlapping with the above description is omitted as appropriate.

In step S11, the image processing apparatus 22 acquires an image from the camera 21. The acquired image is supplied to each of the two-dimensional joint detection unit 51 and the cropping unit 52 corresponding to the camera 21.

In step S12, the two-dimensional joint detection unit 51 extracts the joint positions of the performer A, in other words, the feature points. The extracted feature points are supplied to each of the spatial skeleton estimation unit 53 and the camera position estimation unit 54.

In step S13, the cropping unit 52 crops the image of the performer A to generate the cropped image. The generated cropped image is supplied to the person crop panel generation unit 55.

In step S14, the camera position estimation unit 54 estimates the position of the camera 21 installed in the real space using the feature points supplied from the two-dimensional joint detection unit 51. The information regarding the estimated position of the camera 21 is supplied to the virtual studio rendering unit 58 via the spatial skeleton estimation unit 53 and the switching unit 57.

A method using the calibration board can also be applied to estimate the position of the camera 21. In a case where the position of the camera 21 is estimated using the calibration board, for example, the position of the camera 21 may be estimated before the processing of step S11 is started, and the processing of step S11 and subsequent steps may be performed using the estimated position. In this case, the processing of step S14 can be omitted.

The camera 21 may be provided with a position measuring device such as a global positioning system (GPS) that can measure the position, and the position of the camera 21 may be estimated from information obtained from the position measuring device. In this case, in step S14, position information from the position measuring device may be acquired, or the position information may be acquired at a time point before step S11, and the processing of step S14 may be omitted.

In step S15, the spatial skeleton estimation unit 53 estimates the spatial skeleton of the performer A. The estimation result is supplied to the virtual studio rendering unit 58 as the position of the performer A in the real space.

In step S16, the person crop panel generation unit 55 generates the person crop panel 71 in which the texture, which is the cropped image supplied from the cropping unit 52 and in which the region other than the region where the performer A is imaged is set to transparent, is pasted to the four-vertex planar polygon 72, and supplies the person crop panel to the virtual studio rendering unit 58.

In step S17, the rendering camera setting unit 91 of the virtual studio rendering unit 58 sets the position of the camera 21 installed in the real space in the virtual studio, in other words, the position of the rendering camera 121. The set position information of the rendering camera 121 is supplied to the CG rendering unit 93.

In step S18, the person crop panel setting unit 92 converts the position of the performer A supplied from the spatial skeleton estimation unit 53 into the position in the virtual studio, and installs the person crop panel 71 at the obtained position supplied from the person crop panel generation unit 55. Information such as the position, the orientation, and the size where the person crop panel 71 is installed is supplied to the CG rendering unit 93.

In step S19, the CG rendering unit 93 generates and outputs a composite image obtained by composing the background and the foreground with the person crop panel 71 as a reference. By continuously generating and outputting such a composite image, a composite video is generated and output.

As described above, in the image processing apparatus 22 to which the present technology is applied, processing related to generation of the composite image (composite video) is executed.

<Application Example of Person Crop Panel>

The person crop panel 71 described above can be used in the case of combining the person crop panel with the CG model as described above. The person crop panel can also be used in the following cases.

The person crop panel 71 can be regarded as a 3D object including three-dimensional four-vertex planar polygon information and texture information in which a transparent channel is set for the cropped image. Such a person crop panel 71 can be regarded as, for example, a panel in which a subject such as a person is pasted on a transparent rectangular glass plate with a sticker. Then, such a panel can then be placed in the three-dimensional space. By using such a manner, the person crop panel 71 (device and method for generating the person crop panel 71) can be applied to the following.

In the above-described embodiment, the example in which the person crop panel 71 is generated from the image captured by the camera 21 has been described. However, the person crop panel 71 is not limited to the image captured by the camera 21, and may be generated from another image. For example, the person crop panel 71 may be generated using a recorded video.

In the above-described embodiment, an example has been described in which the person crop panel 71 is a panel in which a texture is pasted to a quadrangular planar polygon. However, the texture may be pasted to a planar polygon having a shape other than the quadrangular shape. The shape of the planar polygon may be set in relation to the relationship between the person crop panel 71 and the image to be composed with.

In the application example in which the person crop panel 71 described below is used, the person crop panel 71 can be composed with another image without having provided with information such as the position of the camera and the position of the subject described above. Therefore, the image that is the basis of the person crop panel 71, the shape of the person crop panel 71, and the like can be made appropriately suitable for the application example.

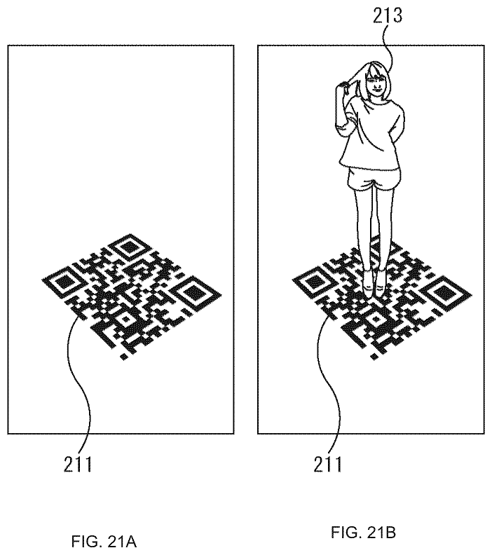

FIG. 21 is a diagram for explaining a case where the person crop panel 71 is used for an augmented reality (AR) application. The AR application can be applied to an application in which, when a camera of a smartphone is directed at a QR code (registered trademark) 211 as shown in A of FIG. 21, an object 213 as shown in B of FIG. 21 appears on the QR code 211.

By generating the object 213 as the person crop panel 71, and composing the object with a live-action video in the real space where the QR code 211 is provided, a composite image (composite video) as shown in B of FIG. 21 can be provided to a user.

It is also possible to generate the person crop panel 71 in which the user imaged by the camera of the smartphone is the object 213, and it is possible to provide the user with a video in which the person crop panel 71 is placed in the real space.

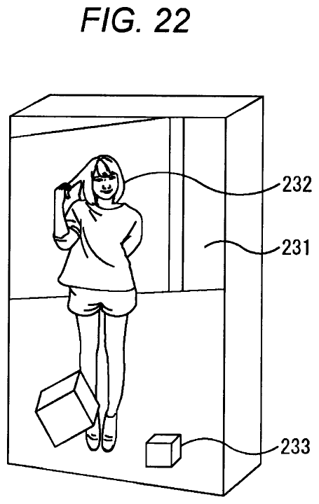

FIG. 22 is a diagram showing an example of a case where the person crop panel 71 is used for an image displayed on a device called a digital mirror or the like. The digital mirror is a device that displays an image captured by a camera, and can be used like a mirror. The digital mirror shown in FIG. 22 displays an imaged person 232, a background 231 of the person 232, and an object 233.

The person 232 is generated as the person crop panel 71 from an image obtained by imaging a person in the real space, and the background 231 is composed with a region set to transparent in the person crop panel 71 including the person 232. The background 231 can be an image generated by CG. Furthermore, the object 233 can be displayed as the foreground of the person 232. The object 233 can be, for example, a cube, a sphere, or the like.

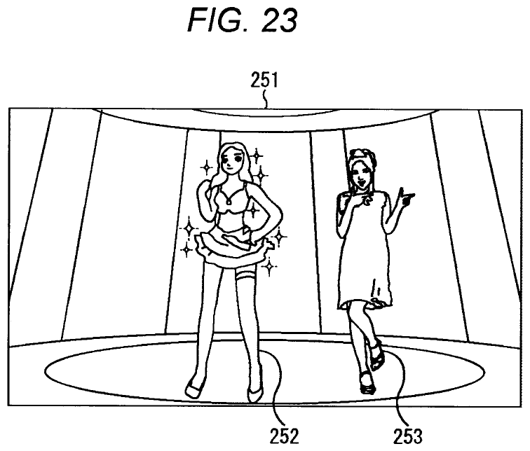

FIG. 23 is a diagram for explaining a case where a person using the person crop panel 71 is displayed together with an image (video) such as a hologram. In a case where live performance is performed using a transparent panel or holography, for example, a hologram performer 252 is displayed on a display unit to be a stage 251.

A person 253 generated by the person crop panel 71 is displayed beside the performer 252. The person 253 can be a video obtained by the person crop panel 71 generated from a live-action video. In this way, by using the person crop panel 71, it is also possible to perform such a performance that a CG character and a live-action character appear at the same time.

The present technology can be applied to other than the above examples, and the application range is not limited to the above examples.

<Recording Medium>

The above-described series of processing can be executed by hardware or software. In a case where the series of processing is executed by software, a program constituting the software is installed in a computer. Here, the computer includes a computer incorporated in dedicated hardware, a general-purpose personal computer or the like that can execute various functions by installing various programs, and the like.

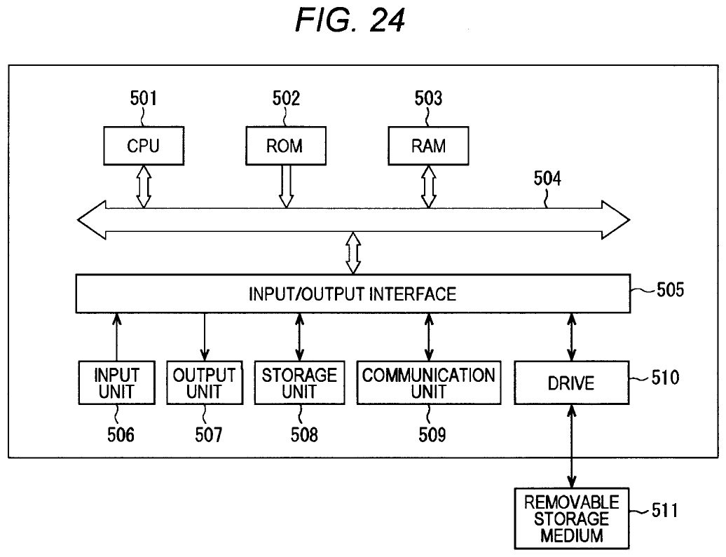

FIG. 24 is a block diagram showing a configuration example of hardware of a computer that executes the above-described series of processing by a program. In the computer, a central processing unit (CPU) 501, a read only memory (ROM) 502, and a random access memory (RAM) 503 are mutually connected by a bus 504. An input/output interface 505 is further connected to the bus 504. The input/output interface 505 is connected with an input unit 506, an output unit 507, a storage unit 508, a communication unit 509, and a drive 510.

The input unit 506 includes a keyboard, a mouse, a microphone, and the like. The output unit 507 includes a display, a speaker, and the like. The storage unit 508 includes a hard disk, a nonvolatile memory, and the like. The communication unit 509 includes a network interface and the like. The drive 510 drives a removable medium 511 such as a magnetic disk, an optical disk, a magneto-optical disk, or a semiconductor memory.

In the computer configured as described above, for example, by the CPU 501 loading a program stored in the storage unit 508 into the RAM 503 via the input/output interface 505 and the bus 504 and executing the program, the above-described series of processing is performed.

The program executed by the computer (CPU 501) can be provided by, for example, being recorded in a removable medium 511 as a package medium or the like. Furthermore, the program can be provided via a wired or wireless transmission medium such as a local area network, the Internet, or digital satellite broadcasting.

In the computer, the program can be installed in the storage unit 508 via the input/output interface 505 by attaching the removable medium 511 to the drive 510. Furthermore, the program can be received by the communication unit 509 via a wired or wireless transmission medium and installed in the storage unit 508. In addition, the program can be installed in the ROM 502 or the storage unit 508 in advance.

Note that the program executed by the computer may be a program in which processing is performed chronologically in the order described in the present description, or may be a program in which processing is performed in parallel or at necessary timing such as when a call is made.

Furthermore, in the present description, the system represents the entire apparatus including a plurality of apparatuses.

Note that the effects described in the present description are merely examples and are not limited, and other effects may be provided.

Note that the embodiment of the present technology is not limited to the above-described embodiment, and various modifications can be made without departing from the gist of the present technology.

Note that the present technology can also take the following configurations.

(1)

An image processing apparatus including a composite image generation unit that generates a composite image by using a panel including captured image information regarding a subject of a captured image and polygon information corresponding to an imaging angle of view of the captured image in a three-dimensional space.

(2)

The image processing apparatus according to (1), in which the captured image information includes a region set to transparent, the region being a region other than the subject in the captured image.

(3)

The image processing apparatus according to (1) or (2), in which the polygon information includes a four-vertex planar polygon.

(4)

The image processing apparatus according to any one of (1) to (3), further including

a setting unit that sets a virtual second imaging device at a position in a virtual space of a first imaging device installed in a real space.

(5)

The image processing apparatus according to (4), in which

the panel is set in the virtual space at a position corresponding to a position of the subject in the real space.

(6)

The image processing apparatus according to (4) or (5), in which

the subject has a position set according to a position of the second imaging device and a feature of the subject.

(7)

The image processing apparatus according to any one of (4) to (6), in which

the panel is set to fill an angle of view of the second imaging device and at a position facing the second imaging device.

(8)

The image processing apparatus according to any one of (4) to (7), in which,

on the basis of a feature point detected from a subject imaged by a predetermined one of the first imaging device among a plurality of the first imaging devices and a feature point detected from the subject imaged by an other of the first imaging device different from the predetermined one of the first imaging device,

the setting unit detects a positional relationship between the predetermined one of the first imaging device and the other of the first imaging device.

(9)

An image processing method including

an image processing apparatus generating a composite image by using a panel including captured image information regarding a subject of a captured image and polygon information corresponding to an imaging angle of view of the captured image in a three-dimensional space.

(10)

An image processing apparatus including

a generation unit that generates, from an image having a predetermined subject captured, captured image information in which a region other than the predetermined subject is set to transparent, and generates a panel to be composed with another image by pasting the captured image information on a planar polygon corresponding to an imaging angle of view in a three-dimensional space.

(11)

The image processing apparatus according to (10), in which

the planar polygon includes a four-vertex polygon.

(12)

The image processing apparatus according to (10) or (11), in which the panel is composed with a computer graphics (CG) image.

(13)

The image processing apparatus according to (10) or (11), in which

the panel is composed with an image obtained by imaging a real space.

(14)

The image processing apparatus according to (10) or (11), in which

the panel is composed with a hologram.

(15)

An image processing method including

an image processing apparatus generating, from an image having a predetermined subject captured, captured image information in which a region other than the predetermined subject is set to transparent, and generating a panel to be composed with another image by pasting the captured image information on a planar polygon corresponding to an imaging angle of view in a three-dimensional space.

(16)

An image processing system including:

an image capturing unit that captures an image of a subject; and

a processing unit that processes a captured image from the image capturing unit,

in which the processing unit includes a composite image generation unit that generates a composite image by using a panel including captured image information regarding a subject of the captured image and polygon information corresponding to an imaging angle of view of the captured image in a three-dimensional space.

### REFERENCE SIGNS LIST

11 Image processing system

21 Camera

22 Image processing apparatus

31 Image processing system

41 Preprocessing apparatus

42 Image processing apparatus

51 Two-dimensional joint detection unit

52 Cropping unit

53 Spatial skeleton estimation unit

54 Camera position estimation unit

55 Person crop panel generation unit

56 Operation unit

57 Switching unit

58 Virtual studio rendering unit

59 CG model storage unit

71 Person crop panel

72 Planar polygon

91 Rendering camera setting unit

92 Person crop panel setting unit

93 CG rendering unit

121 Rendering camera

131, 132 3D model

141, 143, 145, 147 Composite image

211 QR code

213 Object

231 Background

232 Person

233 Object

251 Stage

252 Performer

253 Person

1. An image processing apparatus comprising
a composite image generation unit that generates a composite image by using a panel including captured image information regarding a subject of a captured image and polygon information corresponding to an imaging angle of view of the captured image in a three-dimensional space.

2. The image processing apparatus according to claim 1, wherein
the captured image information includes a region set to transparent, the region being a region other than the subject in the captured image.

3. The image processing apparatus according to claim 1, wherein
the polygon information includes a four-vertex planar polygon.

4. The image processing apparatus according to claim 1, further comprising
a setting unit that sets a virtual second imaging device at a position in a virtual space of a first imaging device installed in a real space.

5. The image processing apparatus according to claim 4, wherein
the panel is set in the virtual space at a position corresponding to a position of the subject in the real space.

6. The image processing apparatus according to claim 4, wherein
the subject has a position set according to a position of the second imaging device and a feature of the subject.

7. The image processing apparatus according to claim 4, wherein
the panel is set to fill an angle of view of the second imaging device and at a position facing the second imaging device.

8. The image processing apparatus according to claim 4, wherein,
on a basis of a feature point detected from a subject imaged by a predetermined one of the first imaging device among a plurality of the first imaging devices and a feature point detected from the subject imaged by an other of the first imaging device different from the predetermined one of the first imaging device, the setting unit detects a positional relationship between the predetermined one of the first imaging device and the other of the first imaging device.

9. An image processing method comprising
an image processing apparatus generating a composite image by using a panel including captured image information regarding a subject of a captured image and polygon information corresponding to an imaging angle of view of the captured image in a three-dimensional space.

10. An image processing apparatus comprising
a generation unit that generates, from an image having a predetermined subject captured, captured image information in which a region other than the predetermined subject is set to transparent, and generates a panel to be composed with another image by pasting the captured image information on a planar polygon corresponding to an imaging angle of view in a three-dimensional space.

11. The image processing apparatus according to claim 10, wherein
the planar polygon includes a four-vertex polygon.

12. The image processing apparatus according to claim 10, wherein
the panel is composed with a computer graphics (CG) image.

13. The image processing apparatus according to claim 10, wherein
the panel is composed with an image obtained by imaging a real space.

14. The image processing apparatus according to claim 10, wherein
the panel is composed with a hologram.

15. An image processing method comprising
an image processing apparatus generating, from an image having a predetermined subject captured, captured image information in which a region other than the predetermined subject is set to transparent, and generating a panel to be composed with another image by pasting the captured image information on a planar polygon corresponding to an imaging angle of view in a three-dimensional space.

16. An image processing system comprising:
an image capturing unit that captures an image of a subject; and
a processing unit that processes a captured image from the image capturing unit,
wherein the processing unit includes a composite image generation unit that generates a composite image by using a panel including captured image information regarding a subject of the captured image and polygon information corresponding to an imaging angle of view of the captured image in a three-dimensional space.
